(19) United States
(12) Patent Application Publication
(10) Pub. No.: US 2004/0003402 A1
(43) Pub. Date: Jan. 1, 2004

(54) Method and apparatus for automatic ticker generation based on implicit or explicit profiling

(75) Inventor: Thomas P. McKenna JR., Sammamish, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Digeo, Inc., Kirkland, WA

(21) Appl. No.: 10/186,334

(22) Filed: Jun. 27, 2002

(51) Int. Cl. G06F 13/00; H04N 5/445; G06F 3/00

(52) U.S. Cl. 725/46; 725/42; 725/140

(57) ABSTRACT

An interactive television ticker is generated is based implicit or explicit user profiling. For tickers based on explicit profiling, a viewer creates a profile that includes information about that viewer (such as gender, income, occupation, address, interests, hobbies, and the like). Based on this explicitly created profile information, only ticker information that matches the profile information is selected and presented in the ticker. In another embodiment, the viewer creates a profile that explicitly selects from among a plurality of available pre-defined tickers. For tickers based on implicit profiling, various viewer behavior and service utilization data can be collected and analyzed to determine the information to scroll in the ticker, without the viewer having to explicitly provide such data. Examples of viewer behavior data can include, but not be limited to, channels watched, programs watched, products purchased, web sites accessed, television and Internet surfing habits, and so forth.

### BACKGROUND OF THE INVENTION

1. Field of the Invention

This disclosure relates generally to presentation of information on a display device, and in particular but not exclusively, relates to presentation of an interactive television “ticker” based on implicit or explicit profiling.

2. Description of the Related Art

It is relatively common to see television programs accompanied by a scrolling “ticker.” The term “ticker” derives from the fact that information in the ticker scrolls sequentially across the bottom of a television screen in a manner analogous to a stock market ticker tape. However, instead of simply including stock market information, current tickers carry a wide variety of other types of information. For instance, tickers that are present on sports channels typically scroll game scores or game schedules. Tickers that are present on news channels scroll the latest headlines, weather reports, or brief news updates.

Tickers are generally encoded in the same analog or digital signal as the television signal. For instance, with Motion Pictures Experts Group (MPEG) digital encoding, the ticker information is included along with the MPEG stream. A graphics generator or other mechanism generates the ticker information at a production studio (or other location) and then combines the ticker information with the television signal. The television signal is then broadcast to viewers. Obviously, with this current implementation, viewers have no control over the content, format, layout, or other presentation aspect of the ticker on their television (including whether or not to even display the ticker), since the production studio maintains such control and since the ticker information is integrated with the received television signal.

Because of this lack of control, viewers share common frustrations with tickers. For example, most tickers scroll from left to right at the bottom of the television screen at a certain speed set by the production studio. Many times, a stock price or sports score of interest to the viewer has scrolled by during a moment that the viewer was not looking at the television screen or was otherwise distracted, thereby causing the viewer to miss the ticker item. As a result, the viewer is forced to wait until the ticker item scrolls by again. This can be an annoying wait for the viewer if there are a large number of ticker items (which are of no interest to the viewer) to scroll through before the particular item of interest reappears. This can be very inconvenient if the viewer is in a rush and cannot afford the spend time to watch a ticker.

This problem highlights the fact that content of conventional tickers are broadcast to all viewers and are not intended to target any particular market or viewer segment. As a result, broadcasters are forced to include content in tickers that are only of a general nature-or, if they want to provide more details and topics in the tickers, they are forced to increase the quantity of information scrolled in tickers so that they can ensure some level of specificity for each ticker topic. The consequence of this action is that, for the most part, viewers pay attention to only a portion of the ticker items that are scrolled and ignore the remainder, but are nevertheless still forced to view all of the content if they wish to locate a ticker item of interest. This reduces the effectiveness of the ticker's intent: to provide viewers with a quick and convenient mechanism for obtaining information.

Interactive television is increasing in use and popularity. With interactive television, viewers can now access many sorts of interactive programming and other interactive content through their television. Using interactive television tickers, interactive service providers can deliver national news, sports, entertainment, and business feeds to interactive television subscribers. Although such interactive television tickers provide some primitive and minimal user/viewer control over selection of subjects of interest (such as sports or finance) through static preferences screens, the ticker itself behaves in much the same way as a broadcast television ticker—the viewer has little control over the selection of information to be presented in the ticker other than what is explicitly provided in the preferences screen.

Simply stated, the static preferences screens do not always capture the subjects of interest to the viewer. For instance, if the viewer selected “sports” in a preferences screen, a ticker will generally scroll all available sports scores and sports news. This result may be unsatisfactory to a viewer who wishes to view only sports news (but not scores) of a particular team for a particular sport (as opposed to scores and news for all teams for all sports). If the viewer has not selected “finance” as a ticker topic, then the ticker may fail to scroll non-sports news related to the team that is potentially of interest to the viewer (such as news of an impending sale of the team).

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an example interactive video casting system that can implement a ticker in accordance with an embodiment of the invention.

FIG. 2 is a block diagram illustrating example components that can be included in the system of FIG. 1 to provide a ticker in accordance with an embodiment of the invention.

FIG. 3 is a block diagram of an embodiment of a client terminal that can be used in the system of FIG. 1 to present a ticker.

FIGS. 4-7 illustrate examples of viewer profiles according to various embodiments of the invention.

FIG. 8 is an example screen shot in conjunction with a remote control for implementing one embodiment of the invention.

FIGS. 9-10 are screen shots depicting generation of a ticker in accordance with various embodiments of the invention.

FIG. 11 is a block diagram illustrating components that can interact to present a ticker based on profiling according to an embodiment of the invention.

FIG. 12 is a flowchart illustrating invocation and presentation of a ticker based on profiling according to an embodiment of the invention.

### DETAILED DESCRIPTION

Embodiments of automatic ticker generation based on implicit or explicit profiling are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention automatically generates a ticker that is based on implicit or explicit user (e.g., viewer) profiling. For example, if the viewer's profile indicates that the viewer is interested in a particular sporting activity (such as fishing) but not in other types of sporting activities (such as golf), a ticker is generated that presents only information pertinent to fishing and excludes golf information. An embodiment of such a ticker may be provided via an interactive television system, and can be created “on the fly” in a manner that reflects a viewer's viewing habits (past or current) or interests.

For tickers based on explicit profiling, various techniques (including combinations thereof) can be used to present viewer-specific ticker information. In one embodiment, the viewer can create a profile that includes information about that viewer (such as gender, income, occupation, address, interests, hobbies, and the like). Based on this explicitly created profile information, only ticker information that matches the profile information is selected and presented in the ticker. In another embodiment, the viewer can create a profile that explicitly selects from among a plurality of available pre-defined tickers, with the tickers in turn being broken up into selectable topics. For instance, the viewer can choose to view only sports tickers, and then, only fishing and baseball topics are selected from the available sports tickers while other sports topics are excluded. The various selected topics can then cycle through an appropriate presentation to the viewer (such as sequentially as individually rendered tickers, or sequentially via a single ticker). In yet another embodiment, a base ticker template is provided. The viewer can create a profile that selects topics (from among a plurality of selectable topics) to fill into the template.

For tickers based on implicit profiling, various viewer behavior data can be collected and analyzed to determine the information to scroll in the ticker, without the viewer having to explicitly provide such data. Examples of viewer behavior data can include, but not be limited to, channels watched, programs watched, advertising click-throughs, request for information (RFI) requests products purchased, web sites accessed, television and Internet surfing habits, and so forth. As one example, data regarding the viewer's television viewing habits can be collected, and then used to identify and present television program listings of interest in a ticker (e.g., a electronic program guide or EPG presented via the ticker).

In one embodiment, the viewer profile information can be used to present targeted advertisements via the ticker, although it is appreciated that content of a non-commercial nature (such as sports scores) can also be presented to the viewer. According to one implementation, a client terminal (such as a set top box) receives all ticker content, and then performs filtering according to the viewer profile, thereby allowing only relevant content to be presented to the viewer by the ticker. An application in an embodiment, such as a profile application or software module, can be used to generate a profile (including populating the profile with viewer data), use the profile to select ticker content, and then determine when a threshold has been reached where it is appropriate to render a ticker that makes sense to the viewer.

The term “ticker” as used herein is intended to generally describe a presentation of information on a display screen, such as a display screen for a television, and is not intended to be limited solely to implementations where the information is presented in a manner to exactly mimic a stock market ticker. In one embodiment, the ticker can comprise text and graphics that are scrolled or otherwise presented in a region of the display screen, along with a television image (such as an image from a live broadcast or from a recorded program). Various embodiments will be described herein in the context of “scrolling” the ticker information. It is to be appreciated that the term “scrolling” is merely illustrative of a technique to present dynamic ticker information, and that this term, in some embodiments, can encompass implementations where the ticker information is presented via screen segments of information, text segments, one-line-at-a-time, one-sentence-at-a-time, one-word-at-a-time, and the like, rather than the traditional format of one-character-at-a-time typically associated with stock market tickers. Moreover, the term “scrolling” is used generically herein for simplicity to refer not only to vertical movement from bottom to top, but also movement from right to left (often referred to as “crawl”) or movement in other directions.

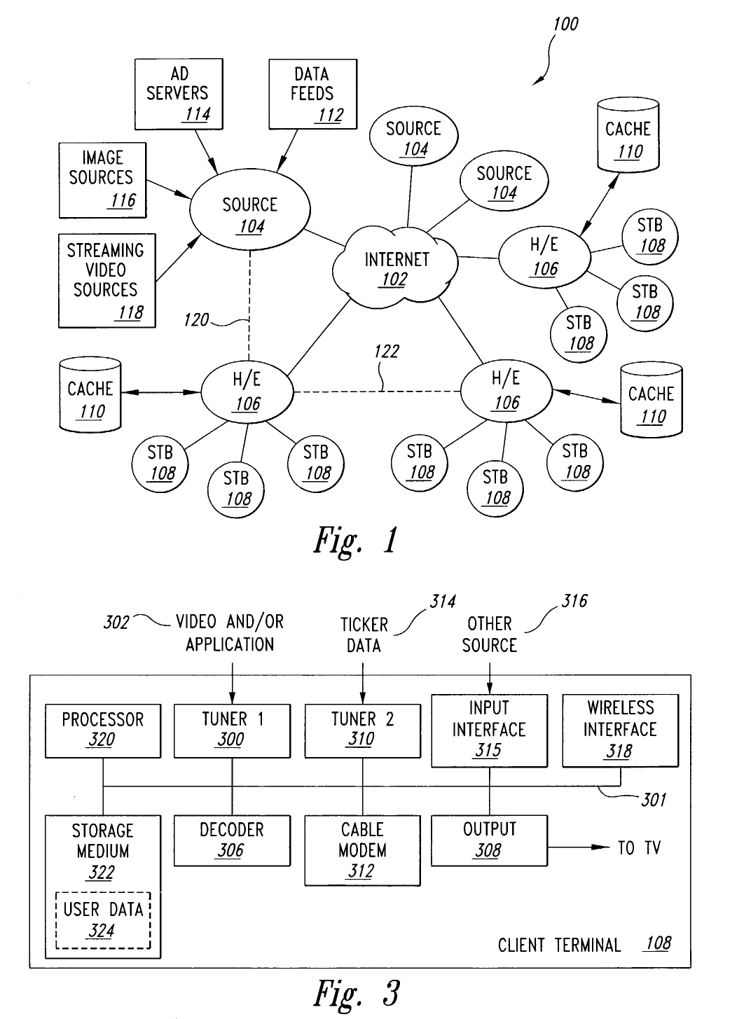

FIG. 1 shows an example of an interactive video casting system 100 for distributing ticker content, Internet content, and television content according to an embodiment of the invention. In accordance with an embodiment of the present invention, the system 100 can be integrated with a cable television distribution system to provide interactive television tickers. The system 100 includes an Internet 102, a plurality of content sources 104, a plurality of distribution centers (depicted as the head-ends or H/Es 106), and a plurality of client terminals 108 (depicted as set top boxes). In addition, a content source 104 is depicted as receiving data from data feeds 112, advertisement servers 114, image sources 116, and streaming video sources 118. The content source 104 may also receive content from a broadcast video source. For the sake of clarity and to avoid clutter, not all of these sources are shown in FIG. 1 for each content source 104.

The plurality of content sources 104 is coupled to the Internet 102. For example, a content source 104 may comprise a web site portal such as Go2Net.com™, or a news web site such as CNN.com™, or other types of sources. Each content source 104 may have various data feeds 112, servers 114, and sources 116/118 coupled to it.

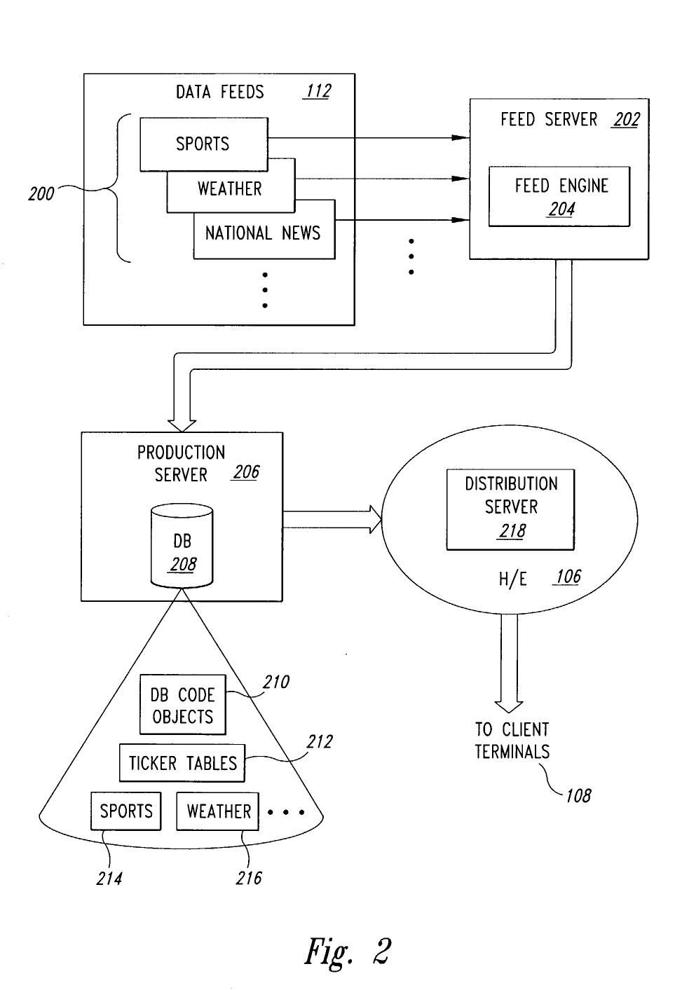

For example, news or stock quote feeds 112 (including data for tickers) may be fed into the content source 104. Servers 114 may provide advertisements for insertion into multimedia content delivered by the content source 104 in accordance with one embodiment of the invention. Sources 116 and 118 may provide images 116, streaming video 118, and other content to the content source 104. Various other feeds, servers, and sources may also be coupled to the content source 104 of FIG. 1. An example configuration of components that can be integrated with the system 100 to provide ticker information to client terminals 108 is shown in FIG. 2.

The Internet 102 comprises a network of networks and is well known in the art. Communications over the Internet 102 can be accomplished using standard protocols such as transmission control protocol/internet protocol (TCP/IP), hypertext transfer protocol (HTTP), file transfer protocol (FTP), or other protocols. Web sites, such as merchant web sites, can be included within or otherwise be in communication with the Internet 102. The Internet 102 is coupled to the plurality of distribution centers 106, and each distribution center 106 is in turn coupled to a plurality of client terminals 108, which may comprise a set top box, a PC, an interactive television set, or another type of communication device or display device.

In alternative or in addition to the Internet 102 being used to distribute multimedia content (including ticker data and advertisements) from the content sources 104 to distribution centers 106, communications channels or networks 120 (which can include satellite delivery sources/networks) apart from the Internet 102 may couple one or more content sources 104 to one or more distribution centers 106. One example of such an alternate path for communications is illustrated by a first dashed line 120 in FIG. 1. Alternately or additionally, peering connections may exist between distribution centers 106. One example of such peering is illustrated by a second dashed line 122 in FIG. 1. Other communications configurations are also possible and are included within the scope of the present invention.

Caches 110 may be provided at (or otherwise coupled to) the distribution centers 106. Such caches 110 may be used to increase the performance in the delivery of multimedia content (including ticker data) to the client terminals 108. For example, larger files for video and other high bandwidth content may be stored in such caches 110, which may be closer-in-time to the client terminals 108 than to the content sources 104. In addition, reliability and guaranteed bandwidth may be provided because the Internet 102 is not in-between such caches 110 and the client terminals 108. In one embodiment, the caches 110 or other storage media in the system 100 can store ticker information (including advertisements), rather than or in addition to having such information buffered, cached, or otherwise stored at the client side.

In an embodiment, servers may be present in the distribution centers 106, with such servers including or being coupled to the caches 110 or other storage media. Alternatively or in addition, these servers may be located remotely from but still communicatively coupled to the distribution centers 106, via the Internet 102 or other communications channels or networks. Examples of such servers that can be used in connection with providing ticker information to client terminals 108 are shown in FIG. 2.

In accordance with one embodiment of the invention, different or multiple portals may be used to access the information provided through the interactive video casting systems of FIG. 1, based on the type of client terminal being used by the end user. That is, for example, a television portal may be provided for an end user that uses a television set coupled to the client terminal 108 to access the information. A PC portal may be provided for an end user that uses a PC to access the information. Portals can be provided for end users that use cellular telephones, personal digital assistants (PDAs), audio devices, and the like to access the interactive video casting system 100 of FIG. 1.

Such portals may be provided in several possible ways. In one embodiment, the client terminal (e.g., the end user's display device or audio device) can be suitably configured with an adapter that includes hardware and software. The adapter converts the television signals, the Internet or web page content, or other information provided from the interactive video casting system into a digitized format or other format that is compatible with the operational features of the particular client terminal 108.

In another embodiment, a cable service provider can deliver signals having different formats to the various client terminals 108, with the client terminals not necessarily having special adapters. Therefore, as an example, the cable service provider or other party can generate/deliver information (e.g., television programming, web page content, ticker information, and the like) having a format that is compatible for end users that receive the information via a television set. The cable service provider or other party can also generate/deliver the same information (e.g., simultaneously with the television portal on the same communication link, separately on a different communication link, on-demand independent of the television portal, and the like) using a format that is compatible with end users that receive the information via PCs, PDAs, cellular telephones, and the like. Thus, the term “interactive video casting system” is used to describe generally a system that can deliver video information and other information over any network and any network-compatible device by broadcasting, multicasting, or unicasting. An “interactive television system” is one type of or one means of access to an “interactive video casting system.”

FIG. 2 is a block diagram illustrating example components that can be included in the system 100 of FIG. 1 to provide data for tickers in accordance with an embodiment of the invention. The data feeds 112 include a plurality of different ticker data feeds 200 that provide a variety of different topical data that can be displayed in a ticker. For instance, the different ticker data can include sports data, weather data, national news, and so forth. The sources that can provide this data can include entities such as Reuters™, The Sporting NeWS™ (TSN), Associated Press™ (AP™), and others (including feeds that can provide advertisements or other shopping-related ticker data). In one embodiment, the ticker data from the data feeds 200 comprises “raw” unformatted data (e.g., data with minimal or no formatting or graphics).

The raw ticker data is provided to a feed server 202. In an embodiment, the feed server 202 operates as a content aggregator that pulls or otherwise receives the raw ticker data from the data feeds 200. The feed server 202 also performs data manipulation on the received ticker data to manipulate the data into a database format so that the data can be indexed and stored. A feed engine 204, which can be embodied in software or other machine-readable instructions stored on one or more machine-readable media according to an embodiment, can reside and run in the feed server 202 to perform at least some of this data manipulation.

The feed server 202 is coupled to provide the manipulated ticker data to a production server 206. The production server 206 includes or is otherwise coupled to a database 208. The feed engine 204 calls on the database 208, and instructs the database 208 where to place the various ticker data. For example, the database 208 can include a plurality of database code objects 210 that cooperate with ticker tables 212 (such as a sports table 214, a weather table 216, and so forth) to index or store ticker data. The feed engine 204 calls the database 208 and identifies the database code objects and ticker tables where the ticker data is to be stored.

The various components of the database 208, such as the ticker tables 212, can also be configured in a manner that optimizes the organization and distribution of the ticker data. For example, ticker data unique to various geographic regions can be segregated from or otherwise identifiable from each other, so that ticker data that is relevant to only particular client terminals 108 need not be broadcast to all client terminals. For instance, California weather information can be segregated from Oregon weather information in the database 208 in a manner that client terminals 108 of California users do not receive Oregon weather information, unless specifically requested. This feature improves transmission efficiency and transmission time, since the bandwidth of communication paths to certain client terminals 108 are not clogged by non-relevant ticker data.

In an embodiment, the production server 206 can also perform data manipulation, such as before the data is stored in the database 208, while it is stored in the database 208, or after the data is retrieved from the database 208 for transmission to client terminals 108. For instance, the production server 206 can perform data manipulation to place the ticker data into a format that is “consumable” or otherwise compatible with operating software of the client terminals 108. For instance, the production server 206 can place the ticker data into formats such as hypertext markup language (HTML), extensible markup language (XML), or other suitable formats.

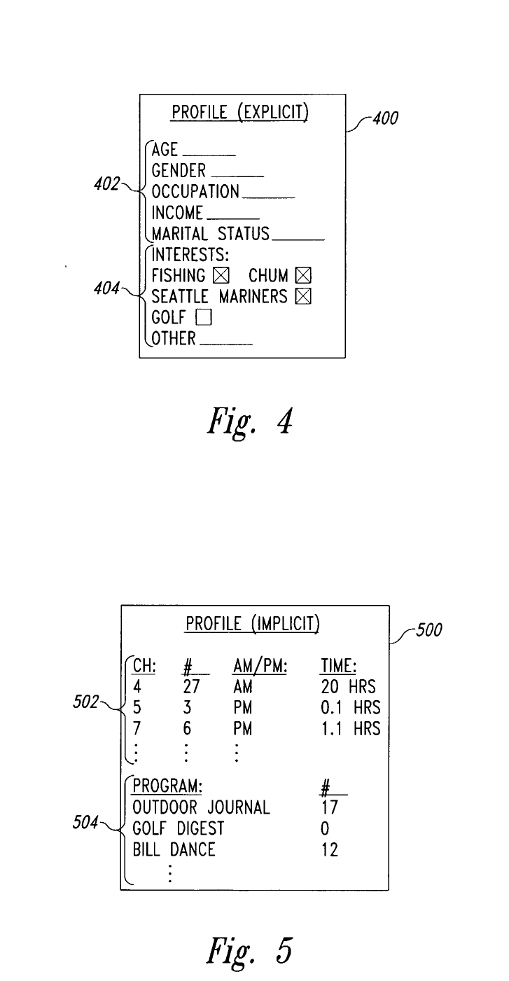

The production server 206 is coupled to provide ticker data from the database 208 to one or more distribution servers 218, which may be located in or otherwise communicatively coupled to a distribution center 106 (such as a head-end). The distribution server 218 operates to provide the ticker data to the client terminals 108 via several possible communication paths or channels, as will be described with reference to FIG. 3.

It is to be appreciated that the components shown in FIG. 2 are merely illustrative of the various components of one embodiment that can be used to provide ticker information. For example, other embodiments can use more or fewer servers, as well as different components, to perform the various operations. Moreover, the various servers and their components (such as the feed engine 204 and the database 208) can be distributed elsewhere in the system 100, instead of or in addition to the locations shown in FIG. 2. There may be multiple feed servers 202, production servers 206 and databases 208, distribution servers 218, and so on to account for load balancing, redundancy in case of outages or broken connections, and other factors that can affect distribution of ticker information.

FIG. 3 is a block diagram of an embodiment of a client terminal 108 for the system 100 of FIG. 1 that can implement an embodiment of the invention to present a ticker. For the sake of simplicity of illustration and explanation, only the components that are germane to understanding an embodiment of the invention are shown in FIG. 3. It is understood that the embodiment of the client terminal 108 shown in FIG. 3 can have other components different than or in addition to what is shown. Moreover, the various illustrated components may be suitably combined in some embodiments, instead of being separate. It also should be noted that the client terminal 108 is only one embodiment of the invention and that some or all of the components described as embodied in the client terminal 108 can be incorporated into a client television rather than in a separate device. A bus 301 is shown symbolically to depict coupling between the various components.

To briefly describe an embodiment, the client terminal 108 receives ticker data and advertisement data from the distribution server 218 or other sources, and then performs the appropriate processing of the data to allow the data to be displayed in a ticker on a display screen of a television set. The client terminal 108 can be passive in that it receives the ticker data (as well as updates) and when the data is sent by the distribution server 218, independently of whether the client terminal 108 requested the ticker data (e.g., the distribution server 218 “pushes” the data to client terminals 108). Alternatively or in addition, the client terminal 108 can poll or otherwise explicitly request the data from the distribution server 218, including polling the distribution server 218 for updated data (e.g., the client terminal 108 “pulls” the data from the distribution server 218). In some embodiments, both push and pull mechanisms may be involved.

Once it receives the ticker data from the distribution server 218, the data can be buffered or cached (if appropriate), and processed for presentation on the display screen of the television set. In an embodiment, ticker software in the client terminal 108 can work in conjunction with a ticker template or other ticker user interface to display the ticker (and its ticker items) in the appropriate scrolling layout, format, locations, time intervals, topics, content, and so forth. In one embodiment where the ticker data is obtained from the Internet 102, this ticker software can comprise browser-based software or other software capable to cooperate with a web browser. According to various embodiments, the ticker can be generated and made interactive through Flash, C++, Java, HTML, or other suitable code or software.

The client terminal 108 comprises a first tuner 300 to tune to a Moving Pictures Experts Group (MPEG) stream 302 or other video source. The stream 302 may include video, live transmission, and/or application code, including corresponding text and graphic resources. In an embodiment where tickers are provided in an integrated manner along with the video signal, the ticker can be received by way of the stream 302. One skilled in the art will recognize that there will be a plurality of streams 302, depending on the number of channels and programs that the cable service provider makes available to the client terminal 108.

The first tuner 300 is coupled to a decoder 306 that decodes the video, application, and/or audio into a format that is compatible with a television set coupled to the client terminal 108. The client terminal 108 may include a second tuner 310. The second tuner 310 can work in conjunction with a cable modem 312 to obtain ticker data 314 from the Internet 102, such as via a Data Over Cable Service Interface Specifications (DOCSIS) connection with the distribution server 218. In addition to the ticker data 314, advertisements, Internet content, and other interactive data can also be received by the client terminal 108 by way of the DOCSIS connection through the second tuner 310 and the cable modem 312. In one embodiment, the second tuner 310 can be used to obtain such interactive data from a server (such as that used by a merchant or advertiser or content provider), remote database, Internet location or web site, or other source depicted in FIG. 1.

In addition, the client terminal 108 includes or is coupled to an input interface 315, through which other sources 316 of ticker data can be provided to the client terminal 108. An example of the input interface 315 comprises an out-of-band tuner that can be used to tune to ticker data that are provided via an out-of-band channel. In an embodiment, the out-of-band channel(s) can comprise one or more low-bandwidth frequencies carried on the same coaxial cable used to provide the MPEG streams and the Internet content. The out-of-band channel(s) tuned to by the input interface 315 to receive ticker data can be used alternatively or in addition to the DOCSIS channel tuned to by the second tuner 310 in such an embodiment. In one embodiment, user transactions or other responses in response to information displayed in a ticker may be communicated to and from the client terminal 108 via the input interface 315.

Further alternatively or in addition, the input interface 315 can comprise another television broadcast tuner (such as the first tuner 300) to tune to one or more channels that may be carrying ticker data. For example, ticker data (including updates) may be broadcast in one or more channel frequencies specifically dedicated for transmission of such data to client terminals 108. Thus, as an illustration, the first tuner 300 can tune to a channel showing a television program, while the input interface 315 is tuned to receive data (in the form of packets, for example) from a ticker channel or other channel to allow a ticker to be simultaneously shown on the same television screen as the television program.

Yet another example of the input interface 315 is an interface to receive outputs of recording devices such as a PVR or a digital video recorder (DVR) that may have ticker data, which may be received via download. Alternatively or in addition, the input interface 315 can comprise a communication interface, such as an Ethernet connection, a digital subscriber line modem, a wireless communication interface, and so forth, which can provide a link to the server 218 to receive ticker data.

An embodiment of the client terminal 108 may include a processor 320 to control operation of the various components shown in FIG. 3. The processor 320 may work in conjunction with ticker software or other machine-readable instructions stored on at least one machine-readable storage medium 322. Such ticker software may cooperate with the processor 320 to invoke a ticker in response to a button press on a remote control, present ticker data in a ticker template or other screen interface or user interface, configure the format and layout of the ticker displayed on the display screen of the television, select information to present a ticker, process received user commands related to responding to information presented in the ticker, and other operations. In an embodiment, the ticker software can be pre-installed in the client terminal 108. In another embodiment, the ticker software may be installed by way of download from the system 100.

An audio and video output subsection 308 of the client terminal 108 receives decoded video and/or other applications (including ticker templates and the ticker data presented therein), and provides the decoded information to a television set. A wireless interface 318 operates to receive commands from a user input device (such as a wireless remote control). Such commands can include user commands to invoke a ticker and other commands related to interaction with the invoked ticker. The wireless interface 318 provides these commands to the processor 320 so that the processor 320 can cooperate with the ticker software to perform the corresponding operation.

In an embodiment of the invention, the storage medium 322 can also store user data 324 related to operation of the ticker. For instance, the user data 324 can include viewer profile information and user settings for the ticker (such as location, font size, topics or other subject matter displayed, and others). In any of these storage locations, multiple sets of user data 324 may be stored, such as in implementations where multiple users in a household log into a same client terminal 108.

The storage medium 322 can include cache(s), buffer(s), or other types of storage locations where ticker data, viewer profile information, or other information may be stored. For example, received sports scores can be stored in the storage medium and retrieved during the appropriate times during the course of the scrolling of the ticker. The ticker data stored in the storage medium 322 can be replaced as updates are received from the distribution server 218. In one embodiment, less time-dependent ticker information (e.g., information that need not necessarily be updated several times per day), including graphics for weather displays, game schedules, some types of advertisements or other shopping information, and the like, can be downloaded to the storage medium 322 during non-peak television viewing periods (such as late at night), and then retrieved from the storage medium 322 when that piece of information is appropriate for presentation in the ticker.

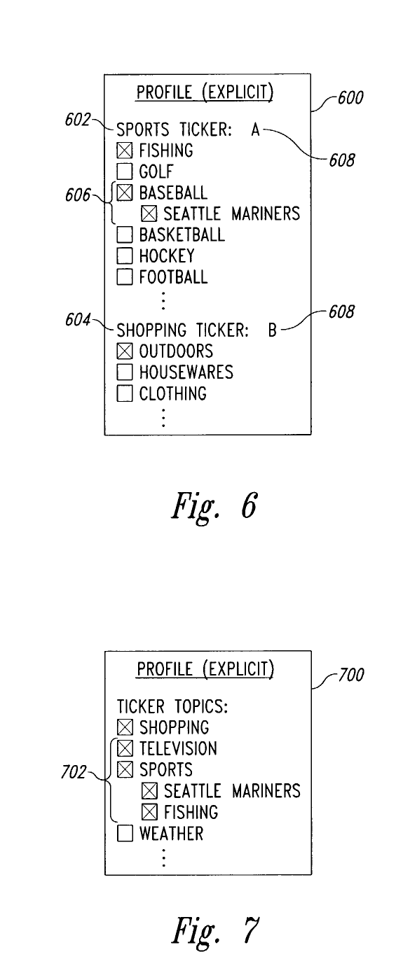

FIGS. 4-7 illustrate example viewer profiles according to various embodiments of the invention. The viewer profile data in these profiles may be collected (and updated) locally at the client terminal 108 or remotely in a suitable location in the system 100 (such as at the caches 110), or a combination of both. Furthermore, the depicted layout, content, organization, methodologies, etc. of these profiles are intended to be merely illustrative, and it is understood that variations are possible. According to various embodiments, the profiles can be implemented as electronic files, database entries, data structures, or other suitable organization of data.

FIG. 4 shows an example explicit viewer profile 400 of a more generic nature (e.g., a profile where ticker selections are not explicitly indicated, and instead include demographic data more specific to and associated with the viewer). Because the profile information in the profile 400 are not specifically directed to ticker choices, there is an increased likelihood that ticker topics of interest will not be excluded from a ticker. For instance, by selecting “fishing” as a general interest, a ticker is more likely to scroll fishing information in diverse subject areas such as fishing tackle advertisements, fishing news reports, fishing television program listings, and so forth.

The profile 400 (as well as other explicit profiles described herein) can be presented to the viewer as a fill-in screen, for instance, when first accessing the system 100, first activating a ticker, or other times when it is appropriate to prompt the viewer to create (or update) a profile. As depicted, the viewer can enter a wide variety of viewer profile information 402 and 404. Examples of viewer profile information 402 can include, but not be limited to, age, gender, occupation, income, marital status, and so forth. Many types of viewer profile information other than what is shown in FIG. 4 may be provided. The viewer profile information 402 may be selected from a plurality of choices (such as by “checking” a selection box for a particular choice) or by using text entry to specifically enter the desired information.

The viewer profile information 404 illustrates possible viewer interest choices, including hobbies. For instance, this particular viewer is interested in fishing and the Seattle Mariners baseball team, and has therefore checked the selection boxes corresponding to these choices. It is noted that one embodiment of the profile 400 provides finer-granularity choices for the viewer. For example, not only can the viewer express an interest in fishing in general, but also, the viewer can express an interest in chum salmon fishing by checking off that selection. Moreover, the viewer can express an interest in a specific baseball team (e.g., the Seattle Mariners), as opposed to having the profile 400 provide a selection for just sports or the sport of baseball. It is also noted that the viewer can choose not to select other interest choices (such as golf), or can enter other choices (via the “Other” field).

FIGS. 6 and 7 illustrate examples of other user profiles that may be created, alternatively or in addition to the profile 400 shown in FIG. 4. That is, while the profile 400 is of a more generic nature, the profiles of FIGS. 6 and 7 are explicit profiles that are created specifically for and directed towards the viewer's ticker viewing preferences. The profiles of FIGS. 6 and 7 may comprise additional pages of the profile 400 in one embodiment, or they may be completely separate from the profile 400 in other embodiments.

FIG. 6 illustrates an embodiment of an explicit profile 600 that allows a viewer to select from a plurality of predefined tickers as part of his profile. For example, two of the predefined tickers that are selectable as part of the profile 600 are a sports ticker selection 602 and a shopping ticker selection 604. For the sports ticker selection 602, a further plurality of selectable predefined tickers can provided, including but not limited to a fishing ticker, golf ticker, baseball ticker, basketball ticker, and so forth. This allows the viewer to increase the amount of customization of the information that is to be presented in a ticker. In this example, the viewer has selected the fishing ticker and the baseball ticker. For each of these tickers, finer-granularity selections are provided so that the viewer can further narrow the scope of the content to be presented in a ticker, such as a selection 606 of Seattle Mariners information for the baseball ticker as depicted in FIG. 6.

In a similar manner, the viewer has selected an outdoors ticker from the shopping ticker selection 604. This selection will cause the shopping ticker to scroll outdoors equipment-related advertisements and other information, while excluding non-outdoors-equipment-related products that have not been selected by the viewer via the profile 600.

There may be any number of ticker selections that can be selected or not selected by the viewer via the profile 600, depending on the level of categorization and information availability provided by the ticker service. Each ticker selection, in turn, can also have any number of possible sub-selections. For instance, in one example embodiment, the sports ticker selection 602 can be accompanied by a list of 50 available sports tickers that are selectable by the viewer.

Via the profile 600, in one embodiment, the viewer can also specify the order in which the information is to be presented in ticker(s). In the depicted embodiment of FIG. 6, the viewer has specified at 608 (via the letter “A”) that the sports information be scrolled first, while the shopping information be scrolled next (via the letter “B”). In one embodiment, the sequence of presentation based on the profile 600 may thus be as follows (if a plurality of different tickers are sequentially presented): invoking the fishing ticker and scrolling the information therein, removing the fishing ticker from presentation after it finishes scrolling, invoking the baseball ticker and scrolling the Seattle Mariners information therein, removing the baseball ticker after it finishes scrolling, invoking the outdoors shopping ticker and scrolling the information therein, removing the outdoors shopping ticker after it finishes scrolling, invoking the next selected ticker and presenting the information therein, and so forth.

In another embodiment, only a single ticker is invoked, yet the information scrolled by that single ticker is based on the sequence specified in the profile 600. Thus, a single ticker is first invoked, and then it sequentially scrolls fishing information, Seattle Mariners information, outdoors shopping information, and so forth. It is appreciated that the viewer may specify other conditions in the profile 600 as to the manner of presentation of the various tickers. For example, the viewer may specify that the fishing ticker be the default ticker whenever ticker invocation occurs. The viewer may specify that for certain channels, only certain tickers are to be invokes. Thus, if the viewer is watching a cooking channel, the viewer may not wish to view sports information at that time, and may therefore specify in the profile 600 that the default ticker to invoke while viewing the cooking channel is the house wares shopping ticker (rather than the baseball ticker). It is understood that many different variations of viewer-specified ticker conditions may be set via the profile 600 (or other explicit profiles).

FIG. 7 illustrates another example of an explicit profile 700. The profile 700 is usable with a single base ticker template, where the viewer can choose the information to be scrolled in the template. According to one embodiment, the profile 700 can be used to add topics to a generally blank base ticker template. In another embodiment, the ticker base template can initially be configured with a full variety of topics, and the profile 700 can be used to remove topics that are not of interest to the viewer.

One embodiment of the profile 700 allows the viewer to select topics of a finer granularity, in a manner similar to the profile 600 of FIG. 6. Thus, selections 702 for sports provide fields where the viewer can select the Seattle Mariners and fishing as subjects of interest to be scrolled in the ticker, while other sports topics are not selected. Another one of the selections of the viewer is “television,” thereby indicating an interest in viewing television program information in the ticker. As with the profile 600, one embodiment of the profile 700 allows the viewer to specify the sequence of presentation, default settings, and other preferences.

FIG. 5 illustrates an example embodiment of an implicit viewer profile 500. In contrast to an explicit viewer profile, the implicit viewer profile 500 is generated without having the viewer explicitly provide information. The profile 500 is generated based on viewer behavior by collecting viewer behavior data, in one embodiment. Examples of such profile information can include, but not be limited to, channels watched, programs watched, advertising click-throughs, RFI requests, frequency of viewing, time and date of viewing, web sites visited, products purchased online, and so forth. Service utilization information, such as data related to viewer use of email, instant messaging, online wallets, and others, can also be collected in one embodiment. Various techniques familiar to those skilled in the art having the benefit of this disclosure can be used to collect and organize the profile information for the profile 500. For instance, cookies, polling of client terminals 108, independent transmission of monitoring data from client terminals 108 to head-ends 106, and other techniques can be used to collect viewer behavior data.

In the profile 500, profile information 502 tracks the channels that the viewer has watched, the number of times that the viewer watched a program on such channels, whether the viewing occurred during AM or PM, and the cumulative amount of time that the viewer watched programming in the channel. It is appreciated that other types of viewing data may be tracked and organized into the profile 500.

Profile information 504 tracks the particular programs that the viewer has watched and the number of times watched, and again, it is appreciated that other viewing information may also be tracked. In the example of FIG. 5, the profile information shows that this particular viewer has viewed the fishing shows “Outdoor Journal” and “Bill Dance” numerous times, while the viewer has not viewed the golf show “Golf Digest.” Based on this information, it can be concluded that presentation of fishing information in a ticker is more likely to generate viewer interest, as opposed to presentation of golf information. It is appreciated that alternatively or in addition to “programs viewed,” the profile information 504 can comprise data reflecting “services used” and the frequency of use.

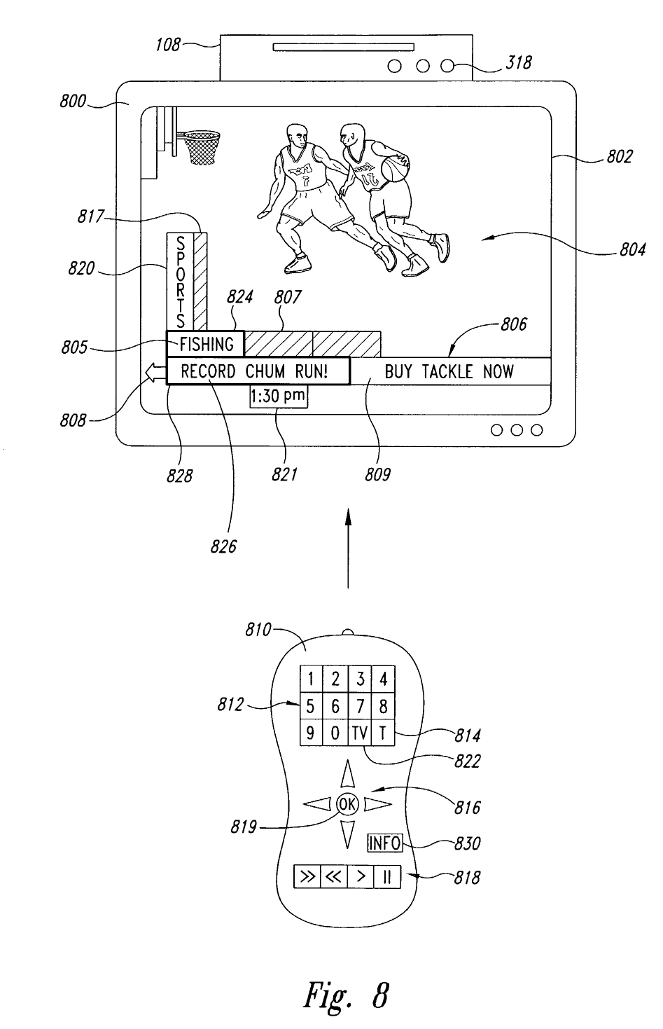

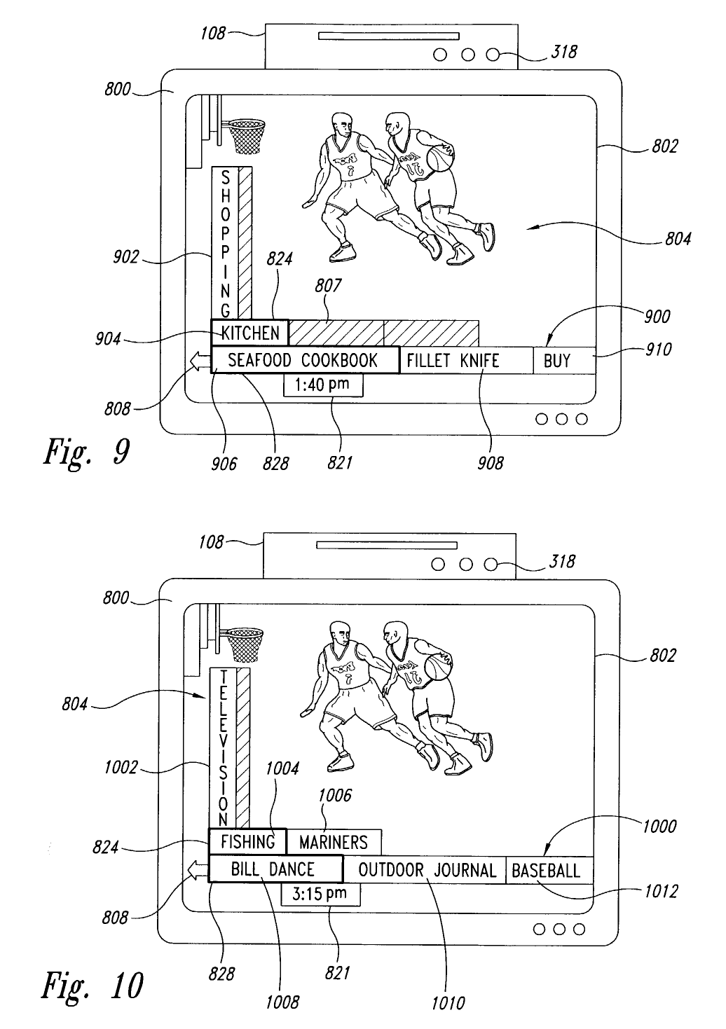

FIG. 8 is an example screen shot in conjunction with a remote control 810 for implementing one embodiment of the invention, and FIGS. 9-10 are television screen shots additionally depicting tickers generated according to viewer profile information in accordance with various embodiments of the invention. For simplicity of explanation, not all of the possible types of information capable of being displayed in tickers based on viewer profile information are shown or described, as such other possible information can be ascertained by examination of the examples specifically shown in the figures. Moreover, it is to be appreciated that the format, layout, direction, content, and other characteristics of the tickers shown in FIGS. 8-10 are merely illustrative and that variations are possible.

In FIG. 8, a television set 800 is coupled to the client terminal 108 in a manner that allows a display screen 802 of the television set to show a television program 804. The television program 804 in this example is a basketball game, and it is appreciated that other types of television programs can be shown, such as commercials, public service announcements, and so forth.

The wireless remote control 810 is in communication with the client terminal 108 (via the wireless interface 318) to perform conventional television-viewing operations and also to invoke and interact with a ticker, as will be described later below for an embodiment. The remote control 810 includes an alphanumeric keypad 812 that the viewer can use to select television channels or to interact with a ticker. Buttons 818 can comprise buttons that are similar to play, rewind, fast forward, pause, etc. buttons usable for recording devices or for ticker operations. Arrow keys 816 may be used for navigation within a ticker or within other applications (such as an EPG), while an OK button 819 may be used to confirm viewer selections.

In an embodiment, the remote control 810 can include a ticker button 814, which if pressed when the user intentionally wishes to view a ticker, causes a command to be sent to the client terminal 108 to instruct the ticker software to render the ticker on the display screen 802. If the ticker button 814 is pressed again, the ticker is taken off the display screen 802. Alternatively or in addition, a TV button 822 can be pressed to dismiss the ticker.

As previously described and illustrated above, one embodiment of the invention creates an explicit and/or implicit viewer profile, and uses the viewer profile information therein to automatically generate one or more tickers that have information tailored to the viewer. In one embodiment, the appropriate ticker is invoked and rendered when the viewer presses the ticker button 814 on the remote control 810 or initiates some other positive invocation action. Alternatively or in addition, invocation of the appropriate ticker may be based on the viewer profile(s). For instance, at least some of the profiles of FIGS. 4-7 may specify that a fishing ticker be automatically invoked every 3 hours, regardless of which channel the viewer is watching, or it may specify that the fishing ticker be invoked only when the viewer tunes to view an outdoors program showing on a particular channel. Many different viewer profile preferences can be specified to set conditions for presentation of one or more tickers.

The television screen shot of FIG. 8 illustrates one embodiment of a ticker 806 that has been invoked and that presents information based on viewer profile information. The ticker 806 is shown scrolling across the bottom of the display screen 802 in a manner that it can display information relevant to this viewer interest. The ticker 806 can be in a screen interface that overlays the television program 804, or the television program 804 may be scaled appropriately on the display screen 802 to fit the screen interface for the ticker 806 and thereby avoid the need for an overlay. An embodiment of the ticker 806 displays the current time 821.

In the example of the ticker 806, the ticker 806 is scrolling from right to left (as symbolically depicted by an arrow 808). It is to be appreciated that in other embodiments, the ticker 806 may be scrolling in different directions and may also be positioned differently on the display screen 802. In accordance with the viewer's profile(s) (recall, for instance, that the generic explicit viewer profile 400 of FIG. 4 indicates that the viewer is interested in chum salmon fishing), the ticker 806 is shown as being in a cycle where it is presenting fishing information (e.g., an announcement of a large salmon run of “Record chum run!” is a moving ticker text item or fishing news item 826 that is being displayed in a scroll region for a “sports” category 820 and a fishing subcategory 805).

There may be any suitable number of categories 817 and subcategories 807 through which the viewer can navigate. In this particular example, the ticker 806 is a “fishing ticker” in that the currently active/selected subcategory (from the sports category 820) is the fishing subcategory 805, with the selection of this ticker content being based on viewer profile information that showed an interest in fishing. Other formats of fishing tickers are possible. For instance, instead of the category-subcategory configuration where multiple different and unrelated topics are available for viewing, an entire ticker may be dedicated solely to fishing content.

In addition to fishing news (e.g., the fishing news item 826), the ticker 806 may also present fishing advertisements 809 or other advertisements that match the viewer profile information. The ticker information, such as news and advertisements, displayed in the ticker 806 may be presented from feeds provided from the components shown in FIG. 2. Local insertion of advertisements from previous downloads is also available. Techniques for automatic advertisement insertion into a ticker that can be used by one embodiment of the invention are disclosed in U.S. application Ser. No. 10/112,071, entitled “AUTOMATIC ADVERTISEMENT INSERTION INTO AN INTERACTIVE TELEVISION TICKER,” filed Mar. 28, 2002, with inventor Thomas P. McKenna, Jr., assigned to the same assignee as the present application, and incorporated herein by reference in its entirety.

A navigation control 824, such as a stationary center focus box into which part(s) of the ticker 806 scroll or a movable selection rectangle, can be used to make navigation selections, such as to view other categories or subcategories. When the items 826 or 809 scroll into a center focus box 828, the viewer can then press an INFO button 830 or the OK button 819 on the remote control 810 so as to view additional details orto begin a purchase transaction. In one embodiment, responding to the items 826 or 809 in this manner results in access of additional information via a hyperlink or other link (which may include channel tuning to another informational source or tuning to additional feeds by the ticker 806). The additional information can be presented in a pop-up window or within the scroll region of the ticker 806 itself. Example embodiments of techniques to provide such additional information are disclosed in U.S. application Ser. No. 10/108,177, entitled “INTERACTIVE TELEVISION TICKER LINKED TO SUPPLEMENTAL INFORMATION, INCLUDING VIDEO HIGHLIGHTS,” filed Mar. 26, 2002, assigned to the same assignee as the present application, and incorporated herein by reference in its entirety.

After scrolling the fishing information (perhaps several repeating cycles of it), the ticker 806 can scroll content from a next sports subcategory 807, which will include Seattle Mariners information according to the viewer profiles of FIGS. 4-7. In one embodiment, the ticker 806 (and/or the various other depicted tickers) automatically switches to this next subcategory (or to the “next ticker” if the category-subcategory configuration is not used) without explicit viewer input/request to do so. In another embodiment, viewer input (via the remote control) is used to switch to the next ticker that matches the viewer's profile, either by navigating to a next category/subcategory in the same ticker 806 or by invoking a different ticker.

FIG. 9 illustrates a shopping ticker 900 that can be presented subsequent to (or alternatively to) ticker presentation of fishing and Seattle Mariners information that match the viewer profile information. Recall that the viewer profile information of FIGS. 4-7 indicated that the viewer has explicitly selected a shopping ticker (in particular, a shopping ticker that presents outdoors products in the explicit profile 600 of FIG. 6) and/or provided topics of interest that can be correlated to products presented in a shopping ticker. Thus, one embodiment of the shopping ticker 900 that closely and directly matches this viewer profile information can present advertisements and other information about fishing equipment (e.g., tackle, clothing, boats, baits, etc.) and/or Seattle Mariners products (e.g., jerseys, trading cards, souvenirs, etc.). However, the embodiment of the shopping ticker 900 in FIG. 9 illustrates a situation where there is not an “exact” or a less-direct match of the viewer profile information-instead, the shopping ticker 900 mixes and matches the best available ticker data.

For example in a shopping category 902 and assuming that there is no available shopping ticker data for fishing equipment, one of the subcategories 807 can include a kitchen subcategory 904, where cooking-related shopping information is presented. In this particular example, the “closest” subcategory related to “fishing” is the “seafood” section of the kitchen subcategory 904. The kitchen subcategory 904 presents a seafood cookbook item 906 and a seafood fillet knife item 908, which may be advertisements or product information that scroll into the center focus box 828. The viewer can view additional information and/or initiate a purchase when the desired item scrolls into the center focus box 828. In one embodiment, the viewer can perform at least part of a purchase transaction within the scroll region of the ticker 900, as depicted by an interactive “buy” item 910 presented by the ticker 900. Example techniques to conduct transactions within the ticker interface are disclosed in U.S. application Ser. No. 10/112,071 referenced above.

FIG. 10 shows another example of a ticker 1000 that is automatically generated based on viewer profile information. In particular, the ticker 1000 scrolls television program listings that match the viewing habits of the viewer depicted in the implicit profile 500 of FIG. 5. In one embodiment, the ticker 1000 includes a television category 1002, which is in turn broken up into various subcategories (which themselves may be configured based on viewer profile information), such as a fishing subcategory 1004, a Seattle Mariners subcategory 1006, as well as subcategories (not shown) for action, adventure, comedy, and so forth.

In the example of FIG. 10, the fishing subcategory 1004 is the currently active subcategory in the center focus box 824, thereby causing the ticker 1000 to scroll programming information related to fishing shows that may be of interest to the viewer and that correlate to the fishing profile information 504 of FIG. 5. For instance, the ticker 1000 scrolls program information 1008 and 1010 for “Bill Dance” and “Outdoor Journal,” respectively. After scrolling fishing program information, the ticker 1000 can scroll baseball program information 1012 related to the Seattle Mariners subcategory 1006.

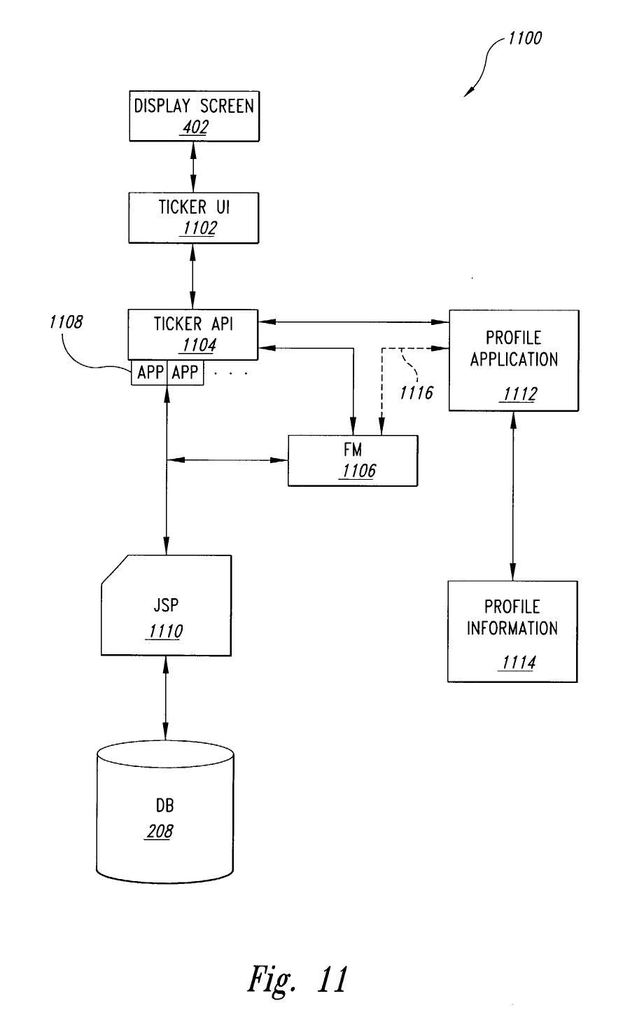

FIG. 11 is a block diagram 1100 illustrating components that can interact to present content in a ticker that is based on viewer profile information according to an embodiment of the invention. At least some of the components of FIG. 11 can be embodied in software or other machine-readable instruction stored on a machine-readable medium, such as the storage medium 322. An embodiment of the ticker software includes a ticker user interface (UI) 1102 that presents a ticker on the display screen 802, as well as being able to receive and process viewer responses. A ticker application program interface (API) 1104 interacts with the ticker UI 1102 to control what the ticker UI displays, how to display, when to display, and so forth. In an embodiment, the ticker API 1104 provides shopping data to the ticker UI 1102, as well as processing user commands that interact with the shopping ticker during transactions (if necessary) and that are entered via the ticker UI 1102.

The ticker API 1104 interfaces with a plurality of applications 1108. These applications can include a sports application, news application, weather application, shopping application, television application, or other applications associated with categories that a ticker can present to the viewer. In one embodiment, at least some of these categories can be associated with pre-defined tickers that are selectable via a viewer profile. A feed manager (FM) 1106 (or other software controller) operates to determine when new or updated ticker information is present and needs to be provided to the ticker API 1104.

It is appreciated that some embodiments need not necessarily implement an API to integrate ticker functionality. In such embodiments, at least some of the ticker functionality can be coded into an operating system without use of an API.

By way of background to generally describe operation of a ticker in an example embodiment (in a situation where it is assumed that ticker data matching the viewer profile has already been identified and selected, and now needs to be presented to the viewer via the ticker), the ticker API 1104 logs and knows what the ticker is displaying, and also knows how often the displayed information needs to be refreshed (based on business rules or other requirements present in functions defined in the ticker UI 1102). In an embodiment, there may be rules in the ticker UI level that define when at least some of the advertisements are to be presented. If it is time for an update, the ticker API 1104 (acting as a container of data) calls a load function that will cause the feed manager 1106 to loop through the applications 1108 to search for new data, and if there is new data, the feed manager 1106 will pass the new data from the application(s) 1108 to the ticker API 1104 so that the ticker API 1104 can pass the new data to the ticker UI 1102.

In another embodiment, the ticker API 1104 manages the information that the ticker UI 1102 will display, but it does not have knowledge of what the ticker UI 1102 displays and when it is displayed. The ticker UI 1102 invokes the lower level components via method calls to retrieve business objects. This means that the invocations of these lower levels are done potentially many times for each accessor/factory method to get a particular business object (assuming that there may be more than one business object needed to gather all data). There are at least two routes that the ticker UI 1102 can take in an embodiment.

First, the ticker UI 1102 invokes the feed manager 1106. This is done in situations when the business object contains some data that needs to be refreshed periodically during the session. The feed manager 1106 receives several arguments that tell it which method in the ticker API 1104 will return the business object, how frequently the feed manager 1106 should poll this business logic, and the name of the ticker UI variable (a collection such as an array) that holds the properties of the business object for the ticker UI 1102 components to use and display. The feed manager 1106 calls the ticker API 1104 immediately, and then at the intervals specified by the ticker UI 1102. Second, the ticker UI 1102 invokes the ticker API 1104 directly. This bypasses the feed manager 1106 and is done for data that only needs to be instantiated once during the session.

In one embodiment for a ticker where the feed manager 1106 (not the ticker API 1104) knows when it is time for an update, the process can be as follows. The ticker UI 1102 calls the ticker API 1104 to start a feed. The ticker API 1104 calls the feed manager 1106, and the feed manager 1106 constructs a callback object. The feed manager 1106 returns an empty object array to the ticker API 1104, which in turn returns the empty object array to the ticker UI 1102.

The feed manager 1106 calls an appropriate application 1108 for a business object, and the business object(s) is returned to the feed manager 1106 in an array, a copy of which is saved by the feed manager 1106 as a business object array. The feed manager 1106 returns the object array to the ticker UI 1102 can calls a HandleLoad function, for instance.

At a particular interval, the feed manager 1106 calls an application 1108 for new information. The business objects are returned to the feed manager 1106 by the application 1108 in an array, and the feed manager 1106 checks that array with the saved array for different information. If the content has changed, then the feed manager 1106 returns an object array to the ticker UI 1102 and calls a HandleLoad function. The ticker UI 1102 calls the ticker API 1104 to stop a feed. The ticker API 1104 calls the feed manager 1106 to stop the feed, and the feed manager 1106 stops the feed.

To obtain new ticker data, in an embodiment, the application(s) 1108 calls a Java server page (JSP) 1110 at a web server (which may be located at the distribution server 218). Java objects at the web server will then communicate with the database 208 to obtain the appropriate ticker information. The Java objects will then construct XML code from the ticker information obtained from the database 208, and send the XML code to the corresponding application 1108. The application 1108 then converts the XML code to local data objects, in one embodiment, and returns the object(s) to the ticker API 1104. The ticker API 1104 subsequently sends the object(s) to the ticker UI 1102 for display in a ticker, via the techniques described above in one embodiment.

According to one embodiment, the ticker data obtained from the database 208 can include metadata, tags, or other type of identifier to identify the nature of that data. As one illustrative example, EPG data to be displayed in a ticker can include metadata that identifies the subject matter of the television programs (e.g., fishing, Seattle Mariners, and the like). Similar content identifiers can be provided for shopping data, sports data, and so forth, such that these identifiers can be detected and matched to viewer profile information, thereby allowing selection of only the content that most closely matches the viewer's interests. Alternatively or in addition, entire feeds (as opposed to individual content of any one feed) are provided with content identifiers. Such content identifiers can be inserted in any suitable location (and by an appropriate party) depicted in FIG. 2.

In one embodiment, a profile application 1112 can be used for operations associated with generation of a ticker based on implicit or explicit profiling. According to various embodiments, the profile application 1112 can comprise a software module, plug-in, one of the applications 1108, or other code that interfaces with the ticker API 1104 and/or the feed manager 1106 (as symbolically depicted by a broken line 1116) in FIG. 11 to provide ticker content to the ticker API 1102.

Various operations performed by the profile application 1112 include, but are not limited to, identification and selection of ticker content from the database 208 that matches the viewer profile information (such as by “reading” the content identifiers for that content), determining whether a sufficient level of matching has been reached between a piece of ticker content and the viewer profile information, generating or updating a viewer profile (including populating the profile with viewer data), monitoring and implementing the profile-specified conditions under which a ticker is to be invoked, and so forth.

The profile application 1112 has access to viewer profile information 1114, which may be stored locally in a storage medium at the client terminal 108 or remotely in the system 100 or both. For the sake of brevity, the various applications or algorithms that may be used to generate and provide access to the viewer profile information 1114 are not described in detail herein, as such details would be familiar to one skilled in the art having the benefit of this disclosure.

In one embodiment, the viewer profile information 1114 can include various selectable ticker templates and/or at least some ticker content that matches the viewer's profile. As one example, base ticker templates (such as pre-defined templates) for sports (fishing and baseball), shopping, and television that match the viewer's profile can be downloaded for later invocation and “filled in” with tailored content. Alternatively or in addition, such ticker templates and ticker content may be stored separately from the viewer profile information 1114, but still accessible by the profile application 1112.

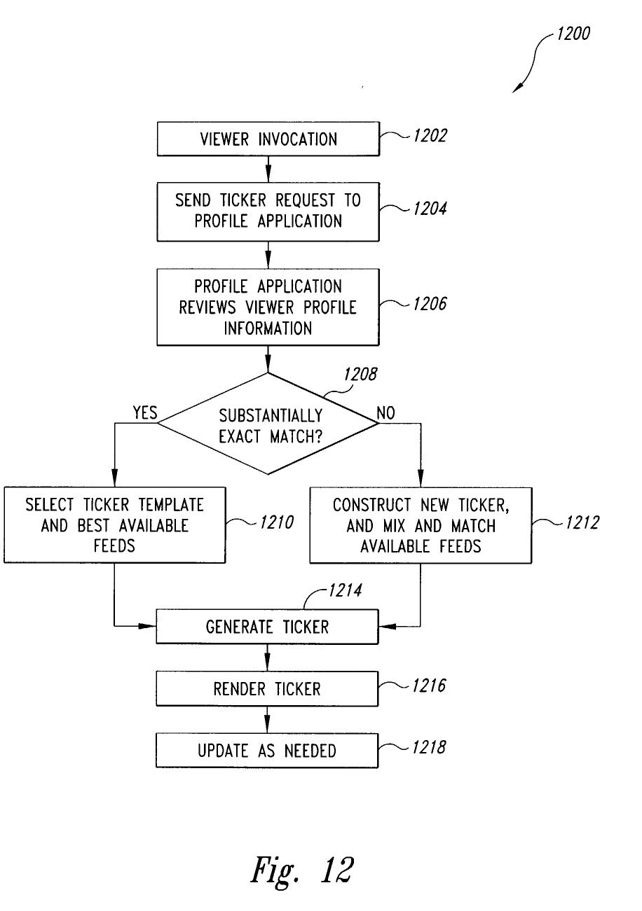

FIG. 12 is a flowchart 1200 illustrating invocation and presentation of a ticker according to an embodiment of the invention, where at least some of the depicted operations can be performed by the profile application 1112. Elements of the flowchart 1200 may be embodied in software or other machine-readable instruction stored on a machine-readable medium, such as the storage medium 322. Moreover, operations shown in the flowchart 1200 need not necessarily occur in the exact order shown.

At a block 1202, a viewer invocation of a ticker is initiated. This may occur, for instance, when the viewer presses the ticker button 814 on the remote control 810. As a result, a request to invoke a ticker is received by the ticker UI 1102 from the remote control 810, and sent to the profile application 1112, in one embodiment, at a block 1204.

Upon receiving this request, the profile application 1112 reviews the viewer profile information 1114 at a block 1206, and makes a determination at a block 1208 whether there is a substantially exact match between the viewer profile information 1114 and available ticker templates (and/or their feeds and data). Thus, in one embodiment, a type of filtering is performed at the client-side where the client terminal 108 receives all of the ticker feeds, and then the profile application 1112 selects data from these feeds to present in a ticker.

Various techniques may be used at the blocks 1206 and 1208 to determine whether there is a substantially exact match. In one example embodiment, the profile application compares the content identifiers of the ticker data with the viewer profile information to locate similar ID numbers (e.g., if fishing is represented in the viewer profile information 1114 by the number “2”, then the profile application 1112 looks for content identifiers of the ticker data that have number 2). A range of numbers may be provided so as to capture a wider variety of potentially relevant content (e.g., viewer profile information for sports may be represented by the range of numbers 1-55, and then the profile application 1112 attempts to locate ticker templates and/or ticker data having identifiers within this range). Tolerances may be set as well (e.g., any content having IDs within plus or minus 5 of the desired ID are selected). Lookup tables may be configured to store such ID numbers for use in comparison at the blocks 1206 and 1208. Other embodiments may use fuzzy logic (or other techniques that would be familiar to those skilled in the art having the benefit of this disclosure) to determine the degree of “closeness” between the profile information and the available templates (and ticker data).

If it is determined at the block 1208 that there is a substantially exact match (e.g., within specified tolerances), then the appropriate corresponding ticker template is selected by the profile application 1112 at the block 1210. In addition, the ticker data from the feed(s) that match the selected ticker and the viewer profile information 1114 is also selected at the block 1210.

If, however, it is determined at the block 1208 that there is not a substantially exact match, then a “new” ticker is constructed at a block 1212 by the profile application 1112. In one embodiment, this “new” ticker can comprise a generic blank ticker template that is formatted with graphics, categories, headings, etc. that match the viewer profile information 1114. Once the new ticker is constructed, the profile application 1112 at the block 1208 selects (via mixing and matching) from available feeds of ticker data, to fill-in the new ticker with ticker data that provides some degree of meaningful relevance to the viewer. An example of a non-exact but still meaningful ticker is depicted in FIG. 9 above.

Once the ticker template and data are selected at the blocks 1210 or 1212, then the appropriate information is passed to the ticker API 1104 and the ticker UI 1102. This results in generation and rendering of a viewer-specific ticker at blocks 1214 and 1216, respectively. Data scrolled by the ticker may be updated as needed, using techniques previously described above, at a block 1218.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

As an example, a satellite television (TV) delivery system may be implemented alternatively or in addition to a cable distribution system. A satellite TV delivery system may comprise a direct broadcast satellite (DBS) system. A DBS system may comprise a small 18-inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center (e.g., analogous to the head-end 106) may be used to gather programming content, ensure its digital quality, and transmit the signal up to the satellites. Programming may come to the broadcast center from content providers (TBS™, HBO™, CNN™, ESPN™, etc.) via satellite, fiber optic cable, and/or special digital tape. Satellite-delivered programming is typically immediately digitized, encrypted and uplinked to the orbiting satellites. The satellites retransmit the signal back down to every earth-station—or, in other words, every compatible DBS system receiver dish at customers' homes and businesses.

Some programs may be recorded on digital videotape in the broadcast center to be broadcast later. Before any recorded programs are viewed by customers, technicians may use post-production equipment to view and analyze each tape to ensure audio and video quality. Tapes may then be loaded into a robotic tape handling system, and playback may be triggered by a computerized signal sent from a broadcast automation system. Back-up videotape playback equipment may ensure uninterrupted transmission when appropriate.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

What is claimed is:

1. A method, comprising:
generating a profile having profile information, wherein at least some of the profile information includes profile information specific to and associated with a user;
based on the profile information in the profile that is specific to and associated with the user, selecting ticker content that corresponds to that profile information; and
rendering a ticker and automatically presenting the selected ticker content in the rendered ticker.

2. The method of claim 1 wherein the profile information specific to and associated with the user comprises user-provided explicit profile information, wherein generating the profile includes populating the profile with the user-provided explicit profile information.

3. The method of claim 2 wherein populating the profile with the user-provided explicit profile information includes receiving the user-provided explicit profile information via a settings screen.

4. The method of claim 1 wherein the profile information specific to and associated with the user comprises implicit profile information.

5. The method of claim 4 wherein the implicit profile information includes data collected based on at least one of viewing behavior data and service utilization data.

6. The method of claim 1, further comprising generating the profile to include user-provided information specific to ticker selections.

7. The method of claim 6 wherein generating the profile to include user-provided information specific to ticker selections includes receiving at least one selection from among a plurality of pre-defined tickers.

8. The method of claim 6 wherein generating the profile to include user-provided information specific to ticker selections includes receiving user selections of specific content to present in a single ticker.

9. The method of claim 1 wherein generating the profile having profile information includes including conditions associated with presentation of the ticker as part of the profile information.

10. The method of claim 1 wherein automatically presenting the selected ticker content in the rendered ticker includes presenting at least one advertisement in the ticker that corresponds to the profile.

11. The method of claim 1 wherein automatically presenting the selected ticker content in the rendered ticker includes presenting electronic program guide information in the ticker that corresponds to the profile.

12. The method of claim 1 wherein selecting ticker content that corresponds to the profile information includes determining a substantially exact match between that profile information and a ticker template, including ticker content to be presented therein.

13. The method of claim 12 wherein determining the substantially exact match includes comparing the profile information with identifiers included with the ticker content.

14. The method of claim 1 wherein selecting ticker content that corresponds to the profile information includes:
constructing the ticker, if a substantially exact match between that profile information and a ticker template is not identified; and
including available ticker content in the constructed ticker.

15. An article of manufacture, comprising:
a machine-readable medium having instructions stored thereon to:
generate a profile having profile information, wherein at least some of the profile information includes profile information specific to and associated with a user;
select ticker content that corresponds to that profile information, based on the profile information in the profile that is specific to and associated with the user; and
render a ticker and automatically present the selected ticker content in the rendered ticker.

16. The article of manufacture of claim 15 wherein the profile information specific to and associated with the user comprises user-provided explicit demographic profile information, wherein the instructions to generate the profile include instructions to populate the profile with the demographic profile information.

17. The article of manufacture of claim 15 wherein the profile information specific to and associated with the user comprises implicit profile information.

18. The article of manufacture of claim 15 wherein the machine-readable medium further includes instructions stored thereon to generate the profile to include user-provided information specific to ticker selections.

19. The article of manufacture of claim 15 wherein the instructions to select ticker content that corresponds to the profile information includes instructions to determine a substantially exact match between that profile information and a ticker template, including ticker content to be presented therein.

20. An apparatus, comprising:
a means for generating a profile having profile information, wherein at least some of the profile information includes profile information specific to and associated with a user;
a means for selecting ticker content that corresponds to that profile information, based on the profile information in the profile that is specific to and associated with the user; and
a means for rendering a ticker and automatically presenting the selected ticker content in the rendered ticker.

21. The apparatus of claim 20 wherein the means for generating the profile having profile information includes a means for populating the profile with user-provided explicit profile information or with implicit profile information.

22. The apparatus of claim 20, further comprising a means for receiving user selection from a plurality of predefined tickers and for including the user selection as part of the profile.

23. A ticker for a video casting system, the ticker comprising:
a plurality of items selected based on profile information, including profile information specific to and associated with a user;
at least one scroll region, capable of being rendered on a display screen, to present the selected items therein; and
a navigation control to allow interactivity with at least one of the selected items presented in the scroll region.

24. The ticker of claim 23 wherein the profile information specific to and associated with the user includes at least one of explicit user profile information and implicit user profile information.

25. The ticker of claim 23, further comprising:
a ticker user interface (UI) to generate the scroll region that presents the selected items and to provide the navigation control to allow interactivity with the at least one of the selected items presented therein;
a ticker application program interface (API) in communication with the ticker (UI) to control presentation of the selected items by the ticker UI and to provide the selected items to the ticker UI; and
a profile application in communication with the ticker API to select and provide the selected items to the to the ticker API based on the profile information.

26. The ticker of claim 25, further comprising a feed manager in communication with the video casting system and with the ticker API to control transmission of ticker data, associated with the selected items, including updates thereof, from the video casting system to the ticker API.

27. An apparatus for a video casting system, the apparatus comprising:
at least one communication interface to receive ticker content;
a storage medium coupled to the communication interface to store a ticker software program, including a profile application;
a processor, coupled to the storage medium and to the communication interface, to cooperate with the profile application to select from the ticker content based on profile information and to cooperate with the ticker software program to control presentation of the selected ticker content within a scroll region of a ticker; and
an output section to provide the ticker and selected ticker content to a display screen.

28. The apparatus of claim 27 wherein the ticker software program includes:
a ticker user interface (UI) to generate the scroll region that presents the selected items;
a ticker application program interface (API) in communication with the ticker (UI) to control presentation of the selected items by the ticker UI and to provide the selected items to the ticker UI, wherein the profile application is in communication with the ticker API to select and provide the selected items to the to the ticker API based on the profile information; and
a feed manager in communication with the video casting system and with the ticker API to control transmission of ticker data, associated with the selected items, including updates thereof, from the video casting system to the ticker API.

29. The apparatus of claim 27 wherein the profile information is stored in the storage medium, the profile information including at least one of implicit user profile information and explicit demographic user profile information.

30. The apparatus of claim 27 wherein the storage medium stores a plurality of pre-defined tickers, the pre-defined tickers being selectable as part of the profile information.

31. A video casting system, comprising:
a source of ticker data; and
an apparatus communicatively coupled to the source, the apparatus including:
at least one communication interface to receive the ticker data from the source;
a storage medium coupled to the communication interface to store a ticker software program, including a profile application;
a processor, coupled to the storage medium and to the communication interface, to cooperate with the profile application to select from the ticker data based on profile information and to cooperate with the ticker software program to control presentation of the selected ticker data within a scroll region of a ticker; and
an output section to provide the ticker and selected ticker data to a display screen.

32. The system of claim 31 wherein the ticker data includes identifiers that can be compared with the profile information by the profile application to determine ticker data that substantially matches the profile information.

33. The system of claim 31 wherein the storage medium stores a plurality of pre-defined tickers, the pre-defined tickers being selectable as part of the profile information.

34. The system of claim 31 wherein the source of the data comprises:
a feed server to receive a plurality of feeds of ticker data and having a feed engine to manipulate the ticker data received from the feeds;
a production server coupled to the feed server to receive the ticker data manipulated by the feed engine, and coupled to a database having tables for the manipulated ticker data received from the feed server, the production server being capable to change a format of the manipulated ticker data to a format compatible with at least one apparatus configured to present the ticker; and
a distribution server to send the manipulated ticker data having the format compatible with the at least one apparatus.

35. A method usable in a video casting system, the method comprising:
generating a profile having profile information, wherein at least some of the profile information includes profile information specific to and associated with a user;
based on the profile information in the profile that is specific to and associated with the user, selecting ticker content that corresponds to that profile information; and
rendering a ticker on a display screen and automatically presenting the selected ticker content in the rendered ticker,
wherein the display screen comprises part of a television for the video casting system,
wherein a client terminal for the television is coupled to the display screen,
wherein the video casting system includes a plurality of sources, which provide the ticker content for the ticker rendered on the display screen, the plurality of sources being communicatively coupled to a plurality of broadcast centers,
wherein at least one of the broadcast centers is coupled to a server capable to provide the ticker content from the sources to the client terminal, and
wherein the video casting system is capable to provide the ticker content to the client terminal via different communication channels, including at least one of a plurality of television broadcast channels, an out-of-band channel, and a communication channel with a communication network.

36. The method of claim 35 wherein the video casting system comprises an interactive television system.

37. A video casting system, comprising:
a source of ticker data including:
a feed server to receive a plurality of feeds of ticker data and having a feed engine to manipulate the ticker data received from the feeds;
a production server coupled to the feed server to receive the ticker data manipulated by the feed engine, and coupled to a database having tables for the manipulated ticker data received from the feed server, the production server being capable to change a format of the manipulated ticker data to a format compatible with client terminals configured to present the ticker data on a display screen; and
a distribution server to send the manipulated ticker data having the format compatible with the client terminals; and
an apparatus coupled to the distribution server of the source, the apparatus including:
at least one communication interface to receive the ticker data from the distribution server;
a storage medium coupled to the communication interface to store a ticker software program, including a profile application;
a processor, coupled to the storage medium and to the communication interface, to cooperate with the profile application to select from the ticker data based on profile information and to cooperate with the ticker software program to control presentation of the selected ticker data within a scroll region of a ticker, the profile information including implicit profile information and user-provided explicit demographic profile information; and
an output section to provide the ticker and selected ticker data to a display screen.

38. The system of claim 37 wherein the source of ticker data comprises part of a satellite television delivery system.
